(19) United States
(12) Patent Application Publication
(10) Pub. No.: US 2026/0213289 A1
(43) Pub. Date: Jul. 23, 2026

(54) Battery Module System

(71) Applicant: JT International SA, Geneva (CH)

(72) Inventors: Grzegorz Aleksander Pilatowicz, Grens (CH); Franck Pourrat, Les Gras (FR)

(73) Assignee: JT International SA, Geneva (CH)

(21) Appl. No.: 19/139,714

(22) PCT Filed: Jan. 25, 2024
(86) PCT No.: PCT/EP2024/051823

§ 371 Date: Jun. 16, 2025

(30) Foreign Application Priority Data
Jan. 30, 2023 (EP) 23154054.3

(51) Int. Cl. H01M 10/48

(52) U.S. Cl. CPC H01M 10/48; H01M 2220/30

(57) ABSTRACT

A battery module system for an aerosol generation device includes a battery sensor device including a light sensor. The battery module system further includes a battery cell including one or more markings. The light sensor is configured to detect a change in a characteristic of the one or more markings indicative of a change in a physical size of at least a region of the battery cell.

### TECHNICAL FIELD

The present disclosure relates to a battery module system for an aerosol generation device. The present disclosure also relates to an aerosol generation device. The present disclosure also relates to a method of monitoring a battery cell of a battery module system.

### BACKGROUND

As the demand for aerosol generation devices increases, so does the call for miniaturisation. In order to reduce the size of these aerosol generation devices, larger components, such as the power source and corresponding features, are minimised. In order to provide a smaller device, while maintaining performance, the energy density of the power source must be increased and the space around the power source is often reduced.

There is also increasing demand to provide aerosol generation devices with accessible and replaceable components, in particular the power source.

When power sources, such as battery cells, come to the end of their usable life, they are often prone to swelling. This swelling is an indication that the battery needs replacing, and is becoming unsafe to use. In some circumstances, swelling of a battery cell can lead to an unwanted thermal event within the aerosol generation device. Swelling of a battery may be an indicator of a defect in the battery. This is particularly the case in battery cells with a higher energy density or soft shell battery cells, such as pouch batteries.

Furthermore, because of the demand for miniaturisation, a heating device is often placed close to the battery cell, thus heating the battery cell locally. A temperature sensor placed, for example, in the centre of the battery cell, would not detect this localised heating of the battery cell, and could lead to an unsafe device being used.

A challenge associated with the above is providing a device that meets growing safety demands. It is the object of the invention to overcome or avoid at least some of the above-referenced problems, or to provide an alternative approach.

### SUMMARY

According to the present disclosure, there is provided a battery module system for an aerosol generation device, an aerosol generation device and a method of monitoring a battery cell of a battery module system including the features as set out in the claims.

According to one aspect, there is provided a battery module system for an aerosol generation device. The battery module system comprises a battery sensor device comprising a light sensor. The battery module system further comprises a battery cell comprising one or more markings. The light sensor is configured to detect a change in a characteristic of the one or more markings indicative of a change in physical size of at least a region of the battery cell.

By providing markings on a battery cell and a light sensor to monitor a change in a characteristic of said markings, the amount of swelling of the battery cell may be determined in a simple, consistent and efficient manner. In other words, a change in the characteristic of said markings is easier to detect compared with the monitoring of the overall size of the battery itself and can lead to an early detection of a change in size, such as a swelling, of a battery. The battery module system may also indicate to the user that a change to their charging and/or power management strategies is required to optimise battery life and/or reduce the the safety risk.

More generally, by monitoring the swelling of the battery cell, a user may be informed of the state of safety of the battery cell. This informs a user when the battery cell is ready to be replaced. Thus the safety and efficiency of the battery module system are improved.

The battery module system described above is able to continuously monitor for a change in shape of the battery cell and isn't reliant upon an activation signal or operation of the device. In other words, it can continuously operate in the background and can provide an early detection of a potential problem.

The characteristic may comprise a size of at least part of the one or more markings.

The advantage of monitoring a size of at least part of the one or more markings is that a change in pixel coverage of the markings may be used to determine the amount of swelling of the battery cell. It is easier and simpler for the battery module system to monitor a change in pixel coverage when compared with having to monitor an overall size of the battery, or the like.

The characteristic may comprise a distance between parts of the one or more markings. The advantage of monitoring the distance between parts of the markings is that simple markings may be used for an early indication of a change in size of the battery.

The battery sensor device may comprise a PCB. The light sensor may be coupled directly to the PCB.

By coupling the light sensor directly to the PCB, the size of the battery sensor device may be reduced, thus allowing for a smaller battery module system.

The battery cell may be a pouch cell.

The advantage of a pouch cell is that the cell is more flexible than traditional metal-can batteries, and can be adapted to the geometry of the battery module system. Thus the size of the battery module system may be reduced.

The battery sensor device may comprise a camera configured to capture a series of images of the one or more markings.

A series of images may show a progressive change in the swelling. Therefore, by providing a camera configured to capture a series of images of the one or more markings, the swelling state of the battery cell may be more accurately and efficienctly measured.

The battery module system may comprise a controller. The controller may be configured to receive a signal from the light sensor, analyse the signal from the light sensor to calculate a change in the characteristic of the one or more markings, and control a function of the aerosol generation device based on the calculated change.

By controlling a function of the aerosol generation device based on the calculated change in the characteristic of the one or more markings, the safety of the battery module system is increased. For example, the controller may stop a user from using a battery cell that is in an unhealthy or unsafe state.

The received signal may comprise information relating to the number of pixels covered by at least a part of the one or more markings in each image in the series of images.

By using the number of pixels (eg pixel width) of at least a part of the one or more markings, the amount of swelling can be more accurately and quickly determined.

The controlled function may relate to an indication to the user that the battery cell requires replacement.

By controlling the aerosol generation device to indicate to a user that the battery cell requires replacement, a user may effectively replace a battery cell at the end of its lifespan, or when a battery has malfunctioned, before the battery cell reaches a potentially unsafe state.

The controller may be configured to determine a state of safety calculation for the battery cell based on the received signal.

The advantage of determining a state of safety calculation of the battery cell is that a user may be informed of the state of the battery cell.

The camera may be a micro-camera.

The advantage of a micro-camera is that less space is used by the camera in the battery module system, thus reducing the size of the system, and therefore the aerosol generation device.

The one or more markings may be located substantially centrally on a wall of the battery cell.

The advantage of this location of the one or more markings is that the battery cell is likely to swell the most towards the centre of the cell, therefore allowing the change in the size of the battery cell to be more quickly and accurately monitored.

The one or more markings may comprise one or more of: one or more lines, a square, a rectangle, a triangle, a circle or an oval.

Lines or shapes such as those listed above will change size under swelling conditions, thus providing easily measurable markings.

According to one aspect, there is provided an aerosol generation device comprising the battery module system as described above and a heater for heating an aerosol precursor material received within the aerosol generation device to generate an aerosol. The battery cell of the battery module system is configured to power the heater.

By providing markings on a battery cell and a camera to monitor a change in a characteristic of said markings, the amount of swelling of the battery cell may be determined. By monitoring the swelling of the battery cell, a user may be informed of the state of safety of the battery cell. This informs a user when the battery cell is ready to be replaced. Thus the safety and efficiency of the aerosol generation device is improved.

The advantage of providing a means of monitoring the swelling of a battery cell in the aerosol generation device, is that a higher material of a higher density may be used while ensuring the safety of the device for a user. Monitoring of a marking on the battery cell ensures rapid feedback on the safety of the battery cell.

Therefore, an aerosol generation device comprising the battery module system allows for a miniaturized system while improving safety.

According to one aspect, there is provided a method of monitoring a battery cell of a battery module system for an aerosol generation device. The method comprises detecting, by a light sensor, a change in a characteristic of one or more markings on the battery cell indicative of a change in the physical size of at least a region of the battery cell.

By monitoring a characteristic of the one or more markings on a battery cell, the amount of swelling of the cell may be determined. By monitoring the swelling of the battery cell, a user may be informed of the state of safety of the battery cell. This informs a user when the battery cell is ready to be replaced. Thus the safety and efficiency of the battery module system is improved.

Further advantages, objectives and features of the present invention will be described, by way of example only, in the following description with reference to the figures. In the figures, like components in different embodiments can exhibit the same reference symbols.

### BRIEF DESCRIPTION OF THE DRAWINGS

Examples of the present disclosure will now be described with reference to the accompanying drawings.

FIG. 1a shows a perspective view of a battery cell;

FIG. 1b shows partial views of the battery cell under different conditions;

FIG. 2a shows a schematic cross-sectional view of a battery module system in an unswollen state;

FIG. 2b shows a schematic cross-sectional view of a battery module system in a swollen state;

FIG. 3 shows a schematic cross-sectional view of an aerosol generation device; and

FIG. 4 shows a flow diagram of a method of monitoring a battery cell of a battery module system.

### DETAILED DESCRIPTION

As used herein, the term “aerosol precursor material”, “vapour precursor material” or “vaporizable material” may refer to a smokable material which may for example comprise nicotine or tobacco and a vaporising agent. The aerosol precursor material is configured to release an aerosol when heated. Tobacco may take the form of various materials such as shredded tobacco, granulated tobacco, tobacco leaf and/or reconstituted tobacco. Nicotine may be in the form of nicotine salts. Suitable aerosol precursor materials include: a polyol such as sorbitol, glycerol, and glycols like propylene glycol or triethylene glycol; a non-polyol such as monohydric alcohols, acids such as lactic acid, glycerol derivatives, esters such as triacetin, triethylene glycol diacetate, triethyl citrate, glycerin or vegetable glycerin. In some examples, the aerosol precursor material is substantially a liquid that holds or comprises one or more solid particles, such as tobacco.

As used herein, the term “aerosol generation device” is synonymous with “aerosol generating device” or “device” may include a device configured to heat an aerosol precursor material and deliver an aerosol to a user. The device may be portable. “Portable” may refer to the device being for use when held by a user. The device may be adapted to generate a variable amount of aerosol, which can be controlled by a user input.

As used herein, the term “aerosol” may include a suspension of vaporizable material as one or more of: solid particles; liquid droplets; gas. Said suspension may be in a gas including air. Aerosol herein may generally refer to/include a vapour. Aerosol may include one or more components of the vaporizable material.

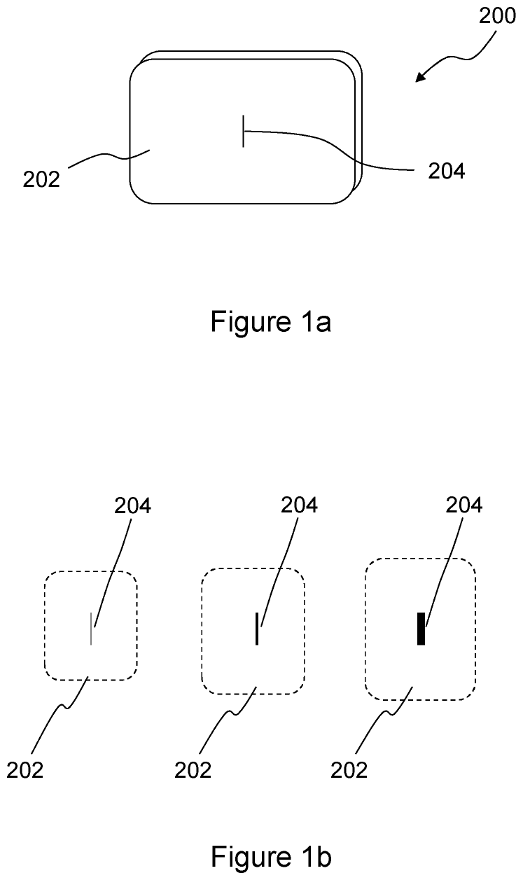

FIG. 1a shows a perspective view of a battery cell 200. The battery cell 200 may be a pouch cell. The battery cell 200 may comprise a first surface 202 (i.e a first wall). The battery cell 200 may comprise a second surface (i.e. a second wall) (not shown). The first surface 202 and the second surface may form the major faces of the battery cell 200. The battery cell 200 may act as the power supply to supply power an aerosol generation device 300.

The battery cell 200 may provide the aerosol generation device 300 with electrical energy providing a voltage in the range of 1 V and 5 V. Preferably the battery cell 200 may provide the aerosol generation device 300 with electrical energy providing a voltage in the range of 3 V and 4.2 V. Most preferably, the battery cell 200 may provide the aerosol generation device 300 with electrical energy providing a voltage of 3.7 V. Such a voltage source is particularly advantageous for a modern aerosol generation device in view of rechargeability, high energy density and large capacity. The battery cell 200 may be a lithium-ion battery cell.

The battery cell 200 comprises one or more markings 204. The one or more markings 204 may be present on the first surface 202. The one or more markings 204 may be square, rectangular, a line, multiple lines, circular, oval, triangular or any other shape that has an easily detectable characteristic, such as width, height and/or circumference. For example, the one or more markings 204 could be two lines spaced apart by a predetermined distance. In this case, the distance between the lines may be measured. The one or more markings 204 may be configured such that when the battery swells, a characteristic or feature of the one or more markings 204 changes. For example, the markings 204 may change in a linear, quasi-linear, exponential or polynomial manner when the battery is subjected to swelling.

The one or more markings 204 may be located substantially centrally on the first surface 202 of the battery cell 200. That is, the one or more markings 204 are located generally centrally on the battery cell 200.

The one or more markings 204 may be black. Alternatively, the one or more markings 204 may be red or another colour that is perceptible.

FIG. 1b shows the effect on the one or more markings 204 of the swelling of the battery cell 200. The left-hand representation shows the marking 204 on a portion of the first surface 202 of the battery cell 200. In this representation, the battery cell 200 is in a healthy, unswollen state. In this state, the state of safety is high. As such, the marking 204 is in its unswollen state. When the battery is in the healthy (i.e. unswollen) state, the width of the one or markings 204 may be between 0.02 mm and 0.5 mm. Preferably, the width of the one or markings 204 may be between 0.05 mm and 0.4 mm. More preferably, the width of the one or markings 204 may be between 0.1 mm and 0.3 mm. Most preferably, the width of the one or markings 204 may be 0.2 mm. In some cases, the width of the one or more markings 204 may be 1 mm.

In this sense, the width of the one or more markings 204 refers to the width of the lines of the one or more markings 204 and is the characteristic of the one or more markings 204 in this example. For other examples of markings 204, such as a square, a rectangular, a circle, an oval, or a triangle etc., the characteristic may be the maximum width of the characteristic (e.g. the diameter of a circle, or the widest point of a triangle).

The middle representation of FIG. 1b shows the marking 204 when the battery cell 200 has undergone some swelling. This may indicate that the battery cell 200 is not in optimum condition, but still may be safe to use. This state may be known as an intermediate state. In this state, the state of safety is medium.

The right-hand representation of FIG. 1b shows the marking 204 when the battery cell 200 has undergone extensive swelling. This may indicate that the battery cell 200 is in an unhealthy (i.e. swollen) state and needs to be replaced. In this state, the state of safety is low.

Under swelling conditions, the width of the one or markings 204 may swell from (for example) 0.2 mm to widths of between 0.3 mm and 0.5 mm. Widths of 0.3 mm to 0.4 mm may be considered as widths at which the battery cell 200 may need replacing. The width of the markings 204 under swelling conditions vary depending on the width of the markings 204 in the healthy condition. That is, it is the increase in width (or other characteristic) that may confer a change in the battery cell 200 from the healthy to the unhealthy state.

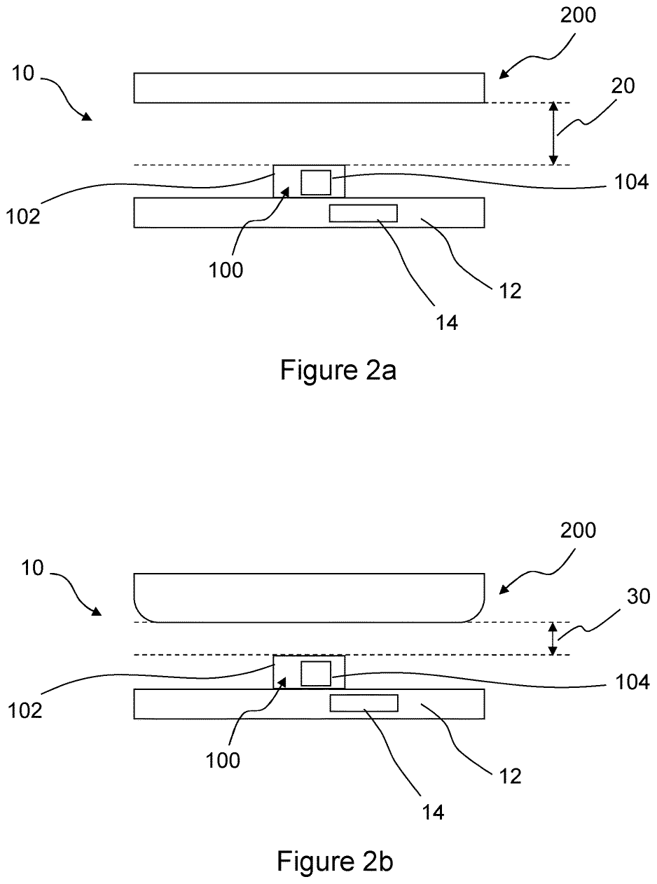

FIGS. 2a and 2b show a cross-sectional schematic view of a battery module system 10 for the aerosol generation device 300. The battery module system 10 comprises a battery sensor device 100. The battery sensor device 100 is configured to detect a change in a characteristic of the one or more markings 204 to monitor a change in a physical size of at least a region of the battery cell 200.

The battery sensor device 100 comprises a light sensor 102. The light sensor 102 is configured to monitor a change in the physical size of at least a region of the battery cell 200. That is, the light sensor 102 is configured to detect a change in a characteristic of the one or more markings 204 of the battery cell 200. For example, the characteristic may comprise a size of at least part of the one or more markings 204. The characteristic may comprise a distance between parts of the one or more markings 204. That is, the light sensor 102 may be configured to detect a change in the width of a line, the distance between lines, the width and/or height of a shape or the circumference of a shape. Other examples of characteristics of the one or more markings 204 may include the length or area of the one or more markings 204. In one example, the characteristics of the one or more markings includes a distance between adjacent lines of the one of the one or more markings 204. The characterstic may include a length, width and/or area of the one or more markings 204. In some examples, more than one characteristic may be combined together (for example, a combination of length and width of the one or more markings).

The light sensor 102 may comprise a camera 104. The camera 104 may be a micro-camera. The camera 104 may be configured to capture images of a portion (i.e. a region) of the surface of the battery cell 200. The camera 104 may be configured to capture a seriors of images of a portion of the surface of the battery cell 200. This portion may include the one or more markings 204.

The battery module system 10 may further comprise a printed circuit board (PCB) 12. The light sensor 102 may be coupled directly to the PCB 12. The battery module system 10 may further comprise a controller 14. As shown in FIGS. 1a and 1b, the controller 14 may be mounted on the PCB 12. Alternatively, the controller 14 may be remote from the PCB 12. The controller 14 may be integral with the battery sensor device 100. The battery sensor device 100 may act as the controller 14. The controller 14 may be configured to receive a signal from the battery sensor device 100 (for example, the light sensor 102) to control a function of the aerosol generation device 300 based on the received signal. The function may be an indication to a user that the battery cell 200 requires replacement.

The light sensor 102 may be configured to transmit images taken by the camera 104 to the controller 14. The light sensor 102 may be configured to transmit data relating to the images to the controller 14. The light sensor 102 may be configured to transmit data related to the change in the characteristic of the one or more markings 204 to the controller 14.

The light sensor 102 and the PCB 12 may be arranged such that the light sensor 102 is positioned between 2 mm and 35 mm away from the one or more markings 204 of the battery cell 200. Preferably, the light sensor 102 may be positioned between 3 mm and 25 mm away from the one or more markings 204 of the battery cell 200. More preferably, the light sensor 102 may be positioned between 4 mm and 18 mm away from the one or more markings 204 of the battery cell 200. Most preferably, the light sensor 102 may be positioned 5 mm away from the one or more markings 204 of the battery cell 200.

The battery sensor device 100 may continuously monitor the state of the battery cell 200. That is, the camera 104 of the battery cell 200 may capture images of the one or more markings 204 of the battery cell 200 at predetermined intervals. For example, the camera 104 may capture an image every second. A higher frequency may be used when the aerosol generation device 100 is in use, for example when heating or charging. A lower frequency may be used when the aerosol generation device 100 is in an idle mode. For example, the camera 104 may be controlled to capture an image in response to an event such as a detection from an accelerometer within the device 100, and/or be configured to capture images every minute. Images captured by the camera 104 may be received by the light sensor 102. Alternatively, the images captured by the camera 104 may be received by the controller 14.

FIG. 2a shows the battery in the healthy (eg unswollen, safe) state. In this state, the distance between the one or more markings 204 on the first surface 202 and the light sensor 102 is a first distance 20. FIG. 2b shows the battery in the unhealthy (eg swollen, unsafe) state. In this state, the distance between the one or more markings 204 on the first surface 202 and the light sensor 102 is a second distance 30. As shown in FIGS. 2a and 2b, the first distance 20 may be larger than the second distance 30.

The combination of the change of the first distance 20 to the second distance 30 and the swelling of the one or more markings 204 between the healthy and unhealthy state of the battery cell 200 may contribute to the change in the apparent size of the one or more markings 204 in the images captured by the camera 104. Data from the camera 104 may be transferred to the controller 14. The controller 14 may be configured to run software to evaluate the characteristic of the markings 204, to determine the absolute swelling level of the battery cell 200. For example, the controller 14 may be configured to analyse received images from the camera 104 using an image processing algorithm. The image processing algorithm may detect the characteristic parameter of the marking 204 this is expected to increase with decreasing safety of the cell battery 200. The controller 14 may be configured to detect a change in the width of a line, the distance between lines, the width and/or height of a shape or the circumference of a shape of the one or more markings 204. The controller 14 may be configured to determine a state of safety calculation for the battery cell 200 based on the received signal (eg received images).

For example, the controller 14 may be configured to determine the width of the one or more markings 204 in terms of the pixels covered. In response to the controller 14 determining that the number of pixels covered by the one or more markings 204 is below a predetermined threshold, the controller 14 may determine that the battery cell 200 is in a healthy state. In response to the controller 14 determining that the number of pixels covered by the one or more markings 204 is equal to or above a predetermined threshold, the controller 14 may determine that the battery cell 200 is in an unhealthy state. Thus, the controller 14 may determine whether the battery cell 200 is in the healthy or unhealthy state.

Alternatively, the light sensor 102 may perform the function relating to the above calucations. The light sensor 102 may then transmit the results to the controller 14.

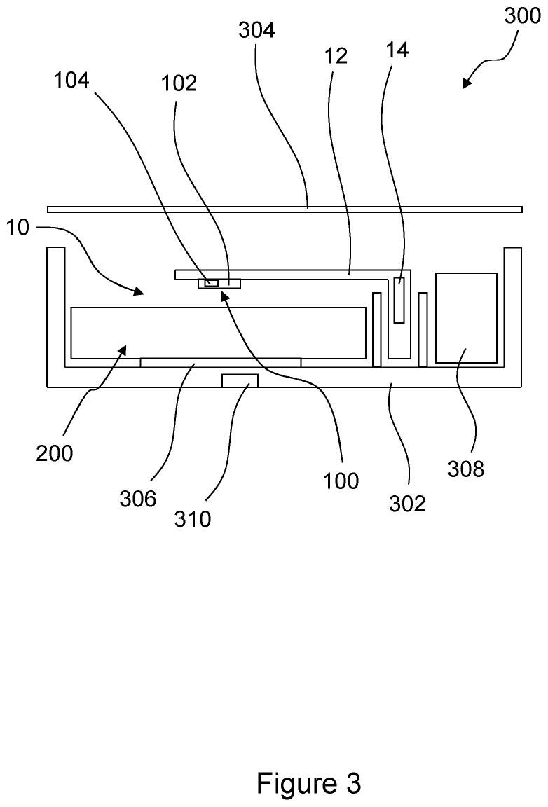

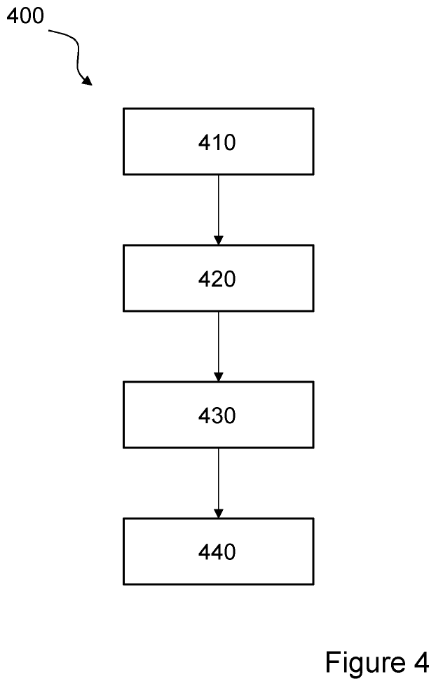

FIG. 3 shows a schematic cross-sectional view of the aerosol generation device 300. The aerosol generation device 300 is suitable for receiving a consumable article (not shown) therein. For example, the aerosol generation device 300 may include a chamber (not shown) in which the consumable article is received. The aerosol generation device 300 may comprise the battery module system 10.

The aerosol generation device 300 may comprise a body 302. The body 302 may be configured to house the components of the aerosol generation device 300. For example, the body 302 may house the battery module system 10. The body 302 may be configured to house the PCB 12 in a manner such that the battery sensor device 100 is held in close proximity to the one or more markings 204 on the first surface 202 of the cell battery 200.

The aerosol generation device 300 may further comprise a spacer 306. The spacer 306 may be positioned between the body 302 and the battery cell 200, thus providing separation between the body 302 and the battery cell 200. The spacer 306 may be a foam spacer. In some examples, the aerosol generation device 300 doesn't include a spacer 306.

The aerosol generation device 300 may comprise a heater 308 configured to provide heat to aerosol precursor material within the consumable article to generate an aerosol, in use. Alternatively, the aerosol generation device 300 comprises a plurality of heaters 308. The heater 308 is configured to receive power from the battery cell 200 of the battery module system 10. The heater 308 is positioned so as to be in thermal contact with the aerosol precursor material of the consumable article to heat it, in use. The heater 308 may be a coil, an induction coil and susceptor arrangement, a ceramic heater, a resistive heater, a flat resistive heater, a mesh heater, a MEMS heater, a thin film heater or the like, configured to heat the aerosol precursor material of the consumable article.

The aerosol generation device 300 may comprise a cover 304. The cover 304 may be configured to enclose the components of the aerosol generation device 300.

The aerosol generation device 300 may comprise an indicator 310. The indicator 310 may be integral with, or located on, the body 302 of the aerosol generation device 300. Alternatively, the indicator 310 may be integral with, or located on, the cover 304. The indicator 310 may be located on an internal component of the aerosol generation device 300 and visible to a user through an aperture, or transparent section, in the body 302 or the cover 304. The indicator 310 may be a component of the battery module system 10.

The indicator 310 may be configured to indicate a state or change in state of the battery cell 200. The indicator 310 may be configured to indicate that the battery cell 200 is in the healthy (unswolled) or unhealthy (swollen) state. The indicator 310 may be further configured to indicate that the battery cell 200 is in an intermediate state.

The indicator 310 may be a light, for example, an LED, configured to be switched between states. For example, the indicator 310 may be configured to be switched between an on-state and an off-state. The indicator 310 may be configured to be switched between colours.

The indicator 310 may be any visual, auditive or haptic feedback function.

The indicator 310 may be configured to be controlled by the controller 14. That is, the controller 14 may control the indicator 310 to switch between states. For example, in response to the controller 14 receiving a signal from the light sensor 104 and calculating a change in the characteristic of the one or more markings 204 that indicates a change from the healthy state to the unhealthy state, the controller 14 may control the indicator 310 to change from a first state to a second state. The signal received from the light sensor 104 may be data related to the change in the characteristic of the one or more markings 204, images taken by the camera 104, data relating to the images, or a combination of these.

The first and second states may be any of the above-described states. The change of state of the indicator 310 may be indicative of the state of safety of the battery cell 200. That is, the indicator 310 may indicate to a user that the battery cell 200 requires replacement.

If calculations performed by the controller 14 on the received data from the light sensor 102 determine the battery cell 200 to be in an unsafe state, the controller 14 may control the aerosol generation device 300 to stop a user from activating the device 300, thus preventing the user from activating a battery cell 200 in an unsafe condition. Upon replacement of the battery cell 200, by a user, the controller 14 may control the aerosol generation device 300 to allow a user to activate the device 300.

A method 400 of monitoring a battery cell 200 of a battery module system 10 comprises the first step 410 of using a light sensor 102 to detect a change in a characteristic of one or more markings 204 on the battery cell 200 indicative of a change in the physical size of at least a region of the battery cell 200. The method 400 may comprise a second step 420 of transmitting, from the light sensor 102, to the controller 14 signals relating to the detected change. The method 400 may comprise a third step 430 of determining, by the controller 14, the state of safety of the battery cell 200 based on the received signals. The method may comprise a fourth step 440 of the controller 14 controlling a function of an aerosol generation device 300 depending on the received state of safety of the battery cell 200. The controlled function of the aerosol generation device 300 may be the state of an indicator 310.

Although preferred embodiments have been shown and described, it will be appreciated by those skilled in the art that various changes and modifications might be made without departing from the scope of the invention, as defined in the appended claims and as described above.

1. An aerosol generation device comprising a battery module system, the battery module system comprising:
a battery sensor device comprising a light sensor, and
a battery cell comprising one or more markings,
wherein the light sensor is configured to detect a change in a characteristic of the one or more markings indicative of a change in a physical size of at least a region of the battery cell, and
a controller configured to:
receive a signal from the light sensor,
analyse the signal from the light sensor to calculate a change in the characteristic of the one or more markings, and
control a function of the aerosol generation device based on the calculated change, wherein the characteristic comprises a distance between parts of the one or more markings.

2. The aerosol generation device according to claim 1, wherein the characteristic further comprises a size of at least part of the one or more markings.

3. The aerosol generation device according to claim 1, wherein the battery sensor device further comprises a PCB, wherein the light sensor is coupled directly to the PCB.

4. The aerosol generation device according to claim 1, wherein the battery cell is a pouch cell.

5. The aerosol generation device according to claim 1, wherein the battery sensor device comprises a camera configured to capture a series of images of the one or more markings.

6. The aerosol generation device according to claim 5, wherein the received signal comprises information relating to a number of pixels covered by at least a part of the one or more markings in each image in the series of images.

7. The aerosol generation device according to claim 1, wherein the controlled function relates to an indication to a user that the battery cell requires replacement.

8. The aerosol generation device according to claim 1, wherein the controller is configured to determine a state of safety calculation for the battery cell based on the received signal.

9. The aerosol generation device according to claim 5, wherein the camera is a micro-camera.

10. The aerosol generation device according to claim 1, wherein the one or more markings are located substantially centrally on a wall of the battery cell.

11. The aerosol generation device according to claim 1, wherein the one or more markings comprises one or more of:
one or more lines;
a square;
a rectangle;
a triangle;
a circle; and/or
an oval.

12. The aerosol generation device according to claim 1, further comprising a heater for heating an aerosol precursor material received within the aerosol generation device to generate an aerosol, wherein the battery cell of the battery module system is configured to power the heater.

13. A method of monitoring a battery cell of a battery module system of an aerosol generation device, the method comprising:
detecting, by a light sensor, a change in a characteristic of one or more markings on the battery cell indicative of a change in the physical size of at least a region of the battery cell,
receiving, by a controller, a signal from the light sensor,
analysing, by the controller, the signal from the light sensor to calculate a change in the characteristic of the one or more markings, and
controlling, by the controller, a function of the aerosol generation device based on the calculated change,
wherein the characteristic comprises a distance between parts of the one or more markings.
